(19) United States
(12) Patent Application Publication
(10) Pub. No.: US 2014/0222548 A1
(43) Pub. Date: Aug. 7, 2014

(54) Inverse Referral Systems and Methods

(71) Applicant: LOOPSIVE, INC., CHICAGO, IL (US)

(72) Inventor: Marcelo Jose Maria Fagalde, Chicago, IL (US)

(73) Assignee: LOOPSIVE, INC., CHICAGO, IL (US)

(21) Appl. No.: 14/171,755

(22) Filed: Feb. 3, 2014

Related U.S. Application Data
(60) Provisional application No. 61/759,411, filed on Feb. 1, 2013.
(60) Provisional application No. 61/806,815, filed on Mar. 29, 2013.

(51) Int. Cl. G06Q 30/02

(52) U.S. Cl. CPC G06Q 30/0242
USPC 705/14.41

(57) ABSTRACT

A system for providing and measuring consumers' product referrals and recommendations about any given product or business, while allowing the consumers to acknowledge who or what influenced their purchase decision (i.e., an inverse referral). As a result the system verifies the purchases in a trending match and builds trend networks of consumers that bought products or services as a result of the referral. The system generates a trending score of the referral source as an indicator of the level of influence each user has in commerce, wherein the trending score measures personal influence in commerce in terms of resulting influenced purchases. The trending score may be used to distribute referral rewards throughout the system.

### CROSS-REFERENCE TO RELATED APPLICATIONS

This application incorporates by reference and claims priority to U.S. Provisional Application 61/759,411 filed on Feb. 1, 2013, and U.S. Provisional Application 61/806,815 filed on Mar. 29, 2013.

### BACKGROUND OF THE INVENTION

The present subject matter relates generally to an inverse referral system for consumers, specifically, a word-of-mouth marketing system that enables businesses to sponsor word-of-mouth referrals from their customers by incentivizing inverse referrals and rewarding their impact in terms of generated sales.

Small businesses' number one need is attracting new customers. Word-of-mouth referrals are the most effective drivers of new customers of small businesses. However, small businesses fail to have the tools to proactively drive and measure word-of-mouth marketing.

With the dramatic increase in consumer connectivity through online sharing and social networking, the way in which people share, consume, and discover new products and services has changed. Currently, via mobile devices and social networks, consumers have the means to be informed by advice from friends and family anywhere and anytime. However, the online websites and social networks fail to effectively track and measure personal influence in commerce.

As a result, there are three main problems that consumers face in commerce: (1) the time and money they waste looking for the best product, store or website; (2) the opportunities they miss when they do not hear about a good deal they would have taken advantage of and, therefore, they either buy the product at a more expensive price or do not buy it at all; and (3) a consumer's personal influence is not measured and, thus, not rewarded by companies.

Word-of-mouth referrals are one of the most powerful and efficient drivers of sales but they are hard to track and quantify. Typically, word-of-mouth referrals in commerce travel mostly off-line and slowly through personal interaction. Even though there are some studies that demonstrate word-of-mouth referrals are one of the most effective drivers of purchases, their effects can only be measured on an aggregated level at which individual contributions are impossible to determine. Even with the outbreak of mobile technologies, this challenge remains to be solved.

Because there is not an effective and easy way to measure and reward purchases originating from word-of-mouth referrals, companies may not invest in marketing directed to increasing word-of-mouth referrals. Instead, companies may ineffectively try to increase sales by investing in indirect methods such as traditional advertising, email marketing, Internet advertising, and text messaging, amongst several other sub-optimal methods. As a result, low conversion rates generate an enormous economic waste that significantly increases the cost of acquiring new customers, thereby, limiting company growth and increasing the prices that consumers pay.

Accordingly, there is a need for a tool able to track, drive and reward personal influence in people's purchases as described herein.

### BRIEF SUMMARY OF THE INVENTION

The present subject matter relates generally to a system and method that provides a set of tools and technology to direct word-of-mouth referrals in commerce, such as shopping, through an online space where people's influence in commerce may be measured and rewarded when a consumer's referral is responsible for generating new sales. More specifically, the present invention relates to providing consumers a tool to spread the word-of-mouth referrals online and offline about any given product, place, or business, while at the same time allowing the consumers to acknowledge who or what influenced their purchase decision (i.e., an inverse referral) and earn rewards in the process. By tracking word-of-mouth referrals, consumer influence may be measured in terms of sales thus allowing businesses to reward each consumer word-of-mouth contribution according to the generated purchases. Hence, the systems and methods verify the purchases in a trending match and build trend networks of consumers that have bought products or services as a result of the referral. The systems and methods may generate a trending map or social graph wherein the users are linked to each other in an influencer-influencee relationship. The systems and methods may generate a trending score as an indicator of the level of influence each user has in a network for any given category in commerce in terms of resulting influenced purchases and calculate the referral rewards earned by the user for sharing products sponsored by participating merchants. The systems and methods are also configured to aggregate all the trending networks of a given product, set of products, business, or geographical and demographical information about the consumers, in a global community of consumers (i.e., a product galaxy).

As described herein, the systems and methods provide businesses with valuable tools to incentivize, track and reward referrals and word-of-mouth referrals, in order to efficiently grow their business by sponsoring their customers. As a result, consumers are provided with valuable information from which to base their shopping decisions by following the trusted advice of people they know, earning rewards and discounts in the process. Moreover, these processes provide businesses with an opportunity to boost, track, monetize and conduct research on the influence that the word-of-mouth referrals have in terms of the sales that each individual consumer drives. Moreover, this tool also provides valuable information for companies and marketing researchers about consumers' journey (i.e. before the purchase decision moment, during the analysis of the consideration set, and after the purchase, during the product consumption or use).

In an embodiment, the system includes a controller and a memory coupled to the controller, wherein the memory is configured to store program instructions executable by the controller. In response to executing the program instructions, the controller is configured to receive a purchase information and a referral data from a consumer, wherein the purchase information includes a product information. The controller may be configured to display the product information on a user interface. The purchase information may include geographic or demographic information associated with the consumer. The controller is further configured to access a database including a plurality of referral accounts associated with at least one product information.

The system may include crawling all of the trend networks to distribute referral rewards offered by participating businesses according to the total amount of the purchases that followed any other given purchase in the network and its position in the network relative to the referral account for which the rewards are being generated. Likewise, the system may also generate a trending score as an indicator of influence in sales for every member of any given trend network associated with the referral account associated with the received referral data.

If the received product information and received referral data matches a referral account and associated account product information in the database, the controller may define a dependency within the database between the referral account and the consumer. The controller is configured generate a trending score associated with the referral account associated with the received referral data, wherein trending score is based on the dependency associated with the referral account. In another example, the controller is further configured to generate the trending score based on at least one of the referral data, the product information, or the number of dependencies defined in the referral account. The controller may be configured to calculate and distribute referral rewards, wherein the referral rewards may be based on at least one of the referral data, the product information, or the number of dependencies defined in the referral account.

In an example, the purchase information includes at least one of a price data, a transaction data, a store data, a brand data, a location data, a time data, or customer feedback data.

The controller may be further configured to calculate a weighted dependency associated with the dependency, wherein the weighted dependency is based on a degree of dependency between the referral account and the consumer, wherein the weighted dependency is stored in the database associated with the dependency, and wherein the trending score is based on the weighted dependencies associated with the referral account.

The referral account may include an identification code indicating a number and a degree of the received referral. For example, the identification code may indicate a degree of dependency between the consumer and the referral account. The number may indicate the order in time the referral data was received by the controller.

The controller may be further configured to generate a trending map based on at least two identification codes, wherein the trending map is in the form of a dependency tree, wherein the dependency tree may include consumers linked in a parent-child relationship (i.e., influencer-influencee relationship). In another example, the controller may be further configured to generate a trending map based on the defined dependencies, wherein the trending map is in the form of a dependency tree.

The controller may be configured to receive purchase verification data before distributing the referral rewards and generating a trending score associated with the consumer. The verification data may include at least one of a product bar code, receipt of purchase, bank account or credit card statement, product series code, mobile device payment information or redeemed coupon code. Further, the verification data may include authorization from a business associated with the purchase information.

The controller may also be configured to generate an incentive associated with the referral account based on the trending score of the referral account, wherein the incentive is redeemable with a business associated with the purchase information, redeemable at other participating businesses in the system or cashed out to a consumer's online account (e.g., bank account, Paypal™ account, etc.). The controller may be configured to communicate the trending score to a business associated with the purchase information.

The incentive may be distributed according to a referral reward based on the purchases generated by any given consumer within a trend network. The referral rewards earned by any given consumer may be redeemable at participating business locations, other participating businesses in the system, or in the form of cash to a consumer's online account. The incentive may be a percentage of the amount spent by the consumer indicating the referral data.

In another embodiment, the system includes a controller and a memory coupled to the controller, wherein the memory is configured to store program instructions executable by the controller. In response to executing the program instructions, the controller is configured to receive a purchase information from a consumer, wherein the purchase information includes a product identification, a price of the associated purchase, and a referral data. The controller is configured to identify a referral account in a database storing a plurality of referral accounts, wherein the identified referral account corresponds to the received referral data. The controller may also be configured to indicate a dependency between the consumer and referral account associated with the received referral data in the database, calculate and distribute the referral rewards, and generate a trending score associated with the referral account, wherein the referral rewards and trending score are based a number of dependencies associated with the referral account.

The controller may also be configured to generate an incentive associated with the referral account based on the trending score of the referral account. The incentive may be associated with a product, set of products or business, wherein the incentive is distributed among the trend network and redeemable at a business associated with the purchase information, other participating businesses in the system, or cashed out to a consumer's online account. In an example, the controller is further configured to calculate and distribute the referral rewards based on the incentive offered by participating businesses for the referred products and at least one of the trending score, purchase information, the price, or the product information. In an example, the controller is configured to generate a referral reward associated with the referral account associated with the received referral data, wherein the referral reward is based on at least one of the trending score, incentive, purchase information, the product information, or a quantity of dependencies associated with the referral account.

In an example, the controller is further configured to generate the trending score based on at least one of the purchase information, the price, or the product information.

The controller may be configured to generate a trending map or social graph based on the defined dependencies, wherein the trending map is in the form of a dependency tree.

The present system is advantageous to consumers by providing a platform for word-of-mouth referrals to be communicated such that consumers may receive referrals from people they trust, save money and time shopping, minimize the chances of missing a good deal, and capture the value that spreading the word about their products or services has for the companies. More effective commerce will emerge as personal advertising, or influence, will be measured in terms of sales, allowing consumers to receive monetary rewards for their influence that ultimately results in a lower and personalized price for each consumer (i.e. each consumer may end up paying the full price of a given product minus, a share of the rewards earned by his or her influencer, minus the rewards earned as a result of his or her own social influence in the product's trend network after sharing the purchase).

Important benefits for the companies include: (a) increased sales by sponsoring trends of specific products or users, resulting in a more effective advertising tool that lowers prices without reducing profits; (b) implementing a marketing system with a more predictable and efficient cost per acquisition by paying only per referred purchase instead of traditional up-front advertising costs; and (c) targeting customers more efficiently by reaching specific communities through influential people with a product tailored for each community's needs.

By providing a set of off-line and online tools that allows consumers to acknowledge other consumers who have influenced them to purchase a given product or service, the system builds networks of consumers who purchased the product or service as a result of it, measuring and rewarding personal influence in commerce in terms of generated sales. The system may generate a product galaxy as a global community of consumers of a given product or set of products, wherein the system provides consumers the ability to share, comment and engage with their fellow consumers around products, brands or activities related with those products or brands they buy.

An object of the invention is to provide a solution to measuring the effect consumer word-of-mouth referrals have in commerce by generating a trend network of consumers that purchase a certain product or service.

Another object of the invention is to provide a solution for the consumers to benefit from the fact that by spreading a referral or just using certain products, such that the consumers influence other people's purchases, thereby driving new sales of the products.

Another object of the invention is to provide a solution for the consumers to interact and share media, experiences or thoughts by providing a communication platform for consumers of a given product or a series of products.

An advantage of the invention is that it provides companies with a measurement of consumers' sales influence, which companies may use to generate incentives to drive further product referrals.

The trending score provides a useful indicator for companies to sponsor endorsements among not only celebrities but also common customers, wherein the sponsorships are designed to influence purchases.

Another advantage of the invention is that it provides a much more efficient system and method for driving new sales. As a matter of fact, most of the options companies currently have to generate new sales depend on the conversion rate of each tool. For instance, advertising requires and initial investment that drives people to the store or website who may or may not purchase the company's product. As a result, the cost per acquisition is not predictable and is an inefficient use of economic resources.

A further advantage of the invention is that it provides the means to make referral information travel faster in commerce, generating benefits for the consumers as the consumers may more easily learn about best deals and products' reviews.

Yet another advantage of the invention is that it generates the incentives for companies to improve product quality and decrease prices, as transparency improves in commerce as a result of the consumers sharing more information about products or services online.

Another advantage of the invention is that it provides an enormous source for research in consumer behavior as different trends of different groups can be studied to design and produce better products for consumers' needs. An improved product-market fit will provide more information about consumers' needs that will be available for companies to design products more efficiently, conserving valuable economic resources.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of an embodiment of the system disclosed herein.

FIG. 2 is a schematic of an example of a consumer interacting with the system.

FIG. 3 is a front view of an example of a database disclosed herein.

FIG. 4 is a flow chart of an embodiment of the system and method disclosed herein.

FIG. 5 is a schematic of a trending network in the form of a trending map.

FIG. 6 is a flow chart of an embodiment of system and method disclosed herein.

FIG. 7 is a schematic of a system including an incentive distribution.

### DETAILED DESCRIPTION OF THE INVENTION

The present disclosure provides systems 10 and methods 11 that track inverse referrals and measure personal influence over sales in any given category of commerce, thereby allowing companies to provide incentives for their customers to refer the company to other consumers. The present system 10 creates value for both consumers and companies. For example, the more consumers refer a company's products, the more sales a company acquires. Similarly, the more a consumer is identified by other consumers as the source of the referral, the more rewards and incentives are provided to the referring consumer. Finally, consumers that acknowledge a referral may also receive a benefit in the form of a discounted price or reward, thereby encouraging participation in the systems 10 and methods 11.

The present system 10 creates a platform where consumers may share their purchases and recommendations, and join the trends of other consumer's purchases and recommendations. The system 10 tracks and measures the influence each customer has in driving new sales based on the customer's referrals and recommendations. As a result, the system 10 also allows companies to invest money more efficiently by providing incentives 40 to their customers for spreading the word and making referrals, wherein the incentives 40 may be economic based, such as discounts, cashbacks or in-store credit, or any other kind of rewards. The system 10 provides a means by which companies may be able to determine an incentive 40 per new sale and provide the incentive 40 to the consumers in the trend network 42 that directly or indirectly influenced the purchase based on each customer's contribution to the referral. Consequently, a consumer that buys a product or service, and everyone else in the trend network 42 who contributed to spread the word to influence the purchase, may receive a share of the incentive 40 provided by the sponsoring business. The way the system 10 splits the incentive 40 between the originating consumer and other consumers within the trend network 42 may depend on the proportion of sales that a consumer's referral is responsible for based on the proportion of the trend network 42 that attributes their purchase to the consumer.

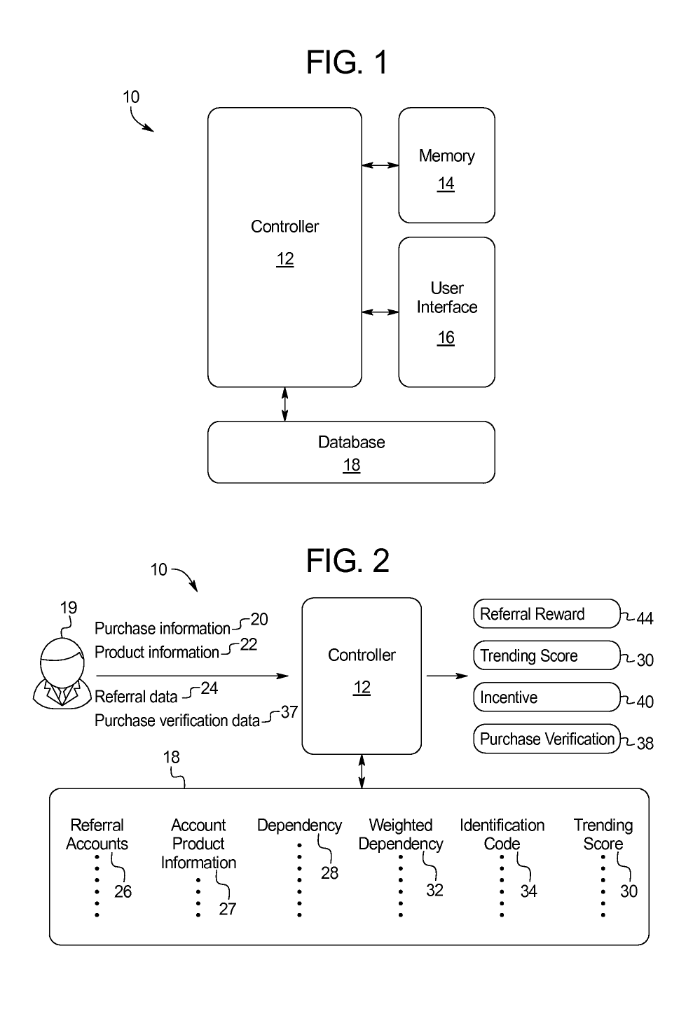

In an embodiment, as shown in FIG. 1, the system 10 includes a controller 12 and a memory 14 coupled to the controller 12, wherein the memory 14 is configured to store program instructions executable by the controller 12. In response to executing the program instructions, the controller 12 is configured to receive a purchase information 20 and a referral data 24 from a consumer 19, wherein the purchase information 20 includes a product information 22, as shown in FIGS. 2 and 4. For example, the referral data 24 may be a name or any identification of a consumer that provided a referral associated with the purchase information 20.

The purchase information 20 may include geographic or demographic information associated with the consumer 19. Alternatively, or in addition to, the purchase information 20 may include at least one of a price data, a transaction data, a store data, a brand data, a location data, a time data, or a consumer feedback data.

The controller 12 may be configured to display the purchase information 20 and/or product information 22 on a user interface 16. For example, the system 10 may display the product information 22 on a user interface 16 that is accessible by a plethora of consumers to learn, follow, and make purchase decisions based on the displayed purchase information 20, product information 20, and/or referral data 24, among other information.

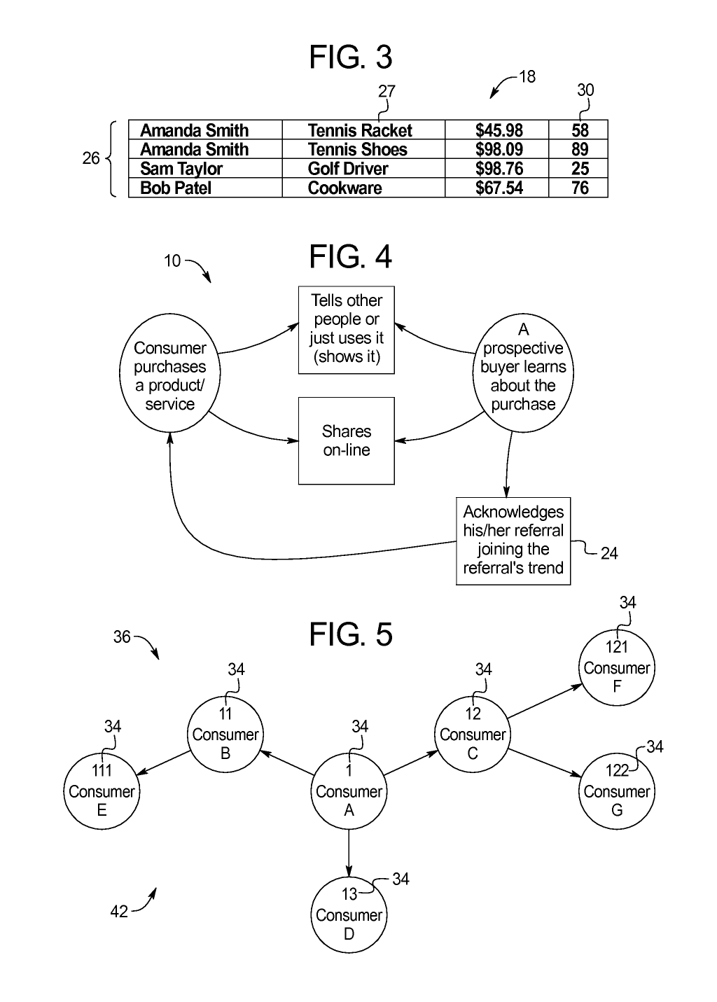

The controller 12 is further configured to access a database 18 including a plurality of referral accounts 26, each associated with at least one account product information 27, as shown in FIG. 3. If the received product information 22 and received referral data 24 matches a referral account 26 and associated account product information 27 in the database, the controller 12 may define a dependency 28 within the database 18 between the referral account 26 and the consumer 19. The controller 12 is further configured to generate a trending score 30 associated with the referral account 26 associated with the received referral data 24, wherein the trending score 30 is based on the dependency 28 associated with the referral account 26.

The trending score 30 is a personal indicator of the consumer's influence in each category of commerce. The trending score 30 allows companies to sponsor endorsements of any consumer, from a celebrity to a common consumer, as the business is able to pay per influenced purchase. The controller 12 may generate the trending score 30 by employing various algorithms. For example, the controller 12 may be further configured to calculate a weighted dependency 32 associated with the dependency 28, wherein the weighted dependency 32 is based on a degree of dependency between the referral account 26 and the consumer 19, wherein the weighted dependency 32 is stored in the database 18 associated with the dependency 28, and wherein the trending score 30 is based on the weighted dependencies 32 associated with the referral account 26.

The referral account 26 may include an identification code 34 indicating a number and a degree of the received referral data 24. For example, the identification code 34 may indicate a degree of dependency between the consumer 19 and the referral account 26.

The controller 12 may be further configured to generate a trending map 36 based on at least two identification codes 34, wherein the trending map 36 is in the form of a dependency tree. In another example, the controller 12 may be further configured to generate a trending map 36 based on the defined dependencies 28, wherein the trending map 36 is in the form of a dependency tree.

In one example, Consumer A may be looking for a new tennis racquet and he finds out that a certain store is offering the best price in the city. He goes to the store, buys the new racquet and “shares the purchase” via the user interface 16 established in the system 10. Subsequently, Consumer A meets Consumer B and tells him about this great purchase opportunity so that Consumer B also purchases the product at the store. Then, Consumer B decides to acknowledge Consumer A's influence by submitting the purchase information 20 and referral data 24 (i.e., Consumer A). In other words, Consumer B joins Consumer's A trend network 42. Consumer C and Consumer D learn from Consumer A about this deal through the use of the systems 10 described herein, and also purchase the product, join the trend network 42, and share their purchase information 20 and referral data 24 within the system 10. The invention assigns a position in the trend to Consumers B, C and D as “First Degree” participants of the trend as all of them acknowledge to have been influenced by Consumer A who generated the trend.

The example may continue wherein Consumer E also purchases the product and acknowledges to have been influenced online or off-line by Consumer B, and Consumers F and Consumer G both of whom acknowledge to have been influenced online or off-line by Consumer C. This new degree of influenced consumers is positioned in the trend network 42 as “Second Degree” participants as they acknowledge to have been influenced by consumers that were influenced by Consumer A. As a result, the word-of-mouth referral is virally spread online and off-line as the trend network 42 continues growing. If the inverse referral is generated by a consumer 19 who buys the product or service and does not have the intention of sharing his purchase, the trend network 42 will indicate an end node instead of a branch in the trending map 36.

The system 10 may assign a relative position of each consumer in the trend network 42 depending on the referral data 24. In the stated example, the trend network 42 is generated using an identification code 34 that assigns a degree and a number. An example of notation and network drawing is the following:

Consumer A: 1

Consumer B: 11; Consumer C: 12; Consumer D: 13—(First degree)

Consumer E: 111; Consumer F: 121; Consumer G: 122—(Second degree)

For example, as shown in FIG. 5, Consumer B has an identification code 34 of 11, wherein the first digit indicates that Consumer B is a First Degree dependency from Consumer A. The second digit in the identification code 34 of Consumer B indicates that Consumer B is the first consumer in time to identify Consumer A as the referral source for Consumer B's purchase. Consumer D has an identification code 34 wherein the first digit indicates that Consumer D is a First Degree dependency from Consumer A. The second digit in the identification code 34 of Consumer D indicates that Consumer D is the third consumer in time to identify Consumer A as the referral source for Consumer D's purchase. For further example, Consumer F has an identification code 34 wherein the first digit indicates that Consumer A was the original source of the referral, that Consumer C was the direct dependency for the referral, and that Consumer F was the first consumer in time to identify Consumer C as the source of the referral for Consumer F's purchase.

The system may continually update the trend network 42 of verified consumers as more consumers join the trend network 42 by acknowledging their referral source (i.e., referral data 24) and verifying their purchases. By providing a verified network of customers who have purchased the product, the system 10 allows companies to promote the word-of-mouth referrals by giving specific benefits, economic incentives, or any other kind of reward to their customers.

For example, the controller 12 may be configured to receive purchase verification data before generating a trend score 30 associated with the referral account 26. The verification data 37 may include at least one of a product bar code, receipt of purchase, bank account statement, product series code, mobile device payment information or redeemed coupon code. Further, the verification data 37 may include authorization from a business associated with the purchase information 20. If the system 10 confirms the purchase verification data 37, the controller 12 is configured to produce a purchase verification 38. The purchase verification 38 may be sent to a business associated with the purchase information 20.

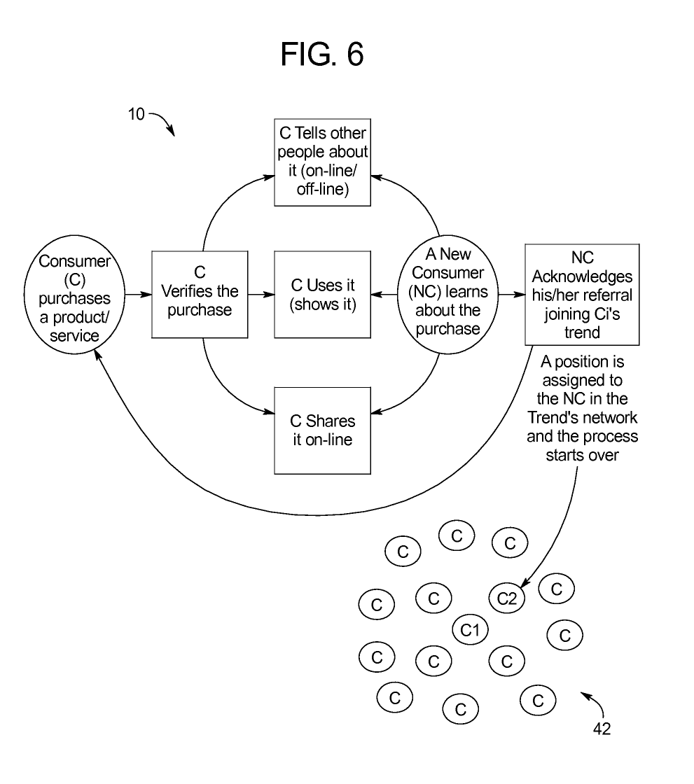

The method through which the purchase may be verified may include a trending match process, as shown in FIG. 6. For example, the verification process may include the inverse referral linked to a specific purchase of a real product or service. The trending match may be performed by several players, including but not limited to, the product's brand company, store, restaurant, website, payment method provider (e.g. Visa) or any other business. This verification process can take place either after the purchase was made or during the purchase.

For example, after the purchase the verifying business asks the consumer to send or upload specific information about the purchase as purchase verification data 37 including but not limited to, product bar code, purchase ticket, bank account statement, credit or debit card statement, product series code, redeemed coupon, mobile device payment information, coupon number or consumer's ID. Once the purchase verification data 37 is sent, the company verifies the purchase through the system 10. The company may communicate the purchase verification 38 to the system 10.

For example, during the purchase the consumer may provide the verifying company personal information that allows the company to link the product or service with the consumer through the system 10. The purchase verification data 37 used by the company may include but, is not limited to, consumer's ID, username, trend network position code or coupon number, QR code or any other online or off-line information that allows the company to link the product or service with the consumer through the system 10.

The controller 12 may also be configured to generate an incentive 40 associated with the referral account 26 based on the trending score 30 of the referral account 26, wherein the incentive 40 is redeemable at a business associated with the purchase information 22. The controller 12 may be configured to communicate the trending score 30 to a business associated with the purchase information 20.

In addition, the controller 12 may be configured to generate a referral reward 44 associated with the referral account 26 associated with the received referral data 24, wherein the referral reward 44 is based the dependency 28 associated with the referral account 26. Alternatively, or in addition to, the referral reward 44 may be based on at least one of the incentive 40, the purchase information 20, the product information 22, or a quantity of dependencies 28 associated with the referral account 26. The referral reward 44 may be an suitable reward to a consumer or consumers within a trend network 42. For example, the referral reward 44 may include cash, direct monetary deposits, discounts, free products, coupons, among others. The referral reward 44 may be redeemable at participating businesses, or cashed out to an online account, among other methods.

For example, a company may decide that it will provide a word-of-mouth economic incentive 40 of 10% of the purchase price (e.g., sponsorship) to its customers for each new sale attributed to the consumer. This incentive 40 may be given in the form of a discount, cash back, in-store credit or any other method for providing an economic incentive to the customers. Although, there are many ways the incentive 40 can be split, for example, the incentive 40 may be split 50%-50% between the influencer and the influence, or shared on a pro-rata basis across two or more customers that contributed to the word-of-mouth referral that led to the purchase.

For example, Consumer A may be a trend generator, as he buys the product and does not acknowledge anyone as his referral (referral data 24). Consumer A gets 50% of the sponsorship incentive 40. In the example of a 10% sponsorship reward, Consumer A receives 5% of the purchase price as a discount, cash back, points or in-store credit depending on how the incentive 40 is implemented.

For further example, Consumer B acknowledges Consumer A as the referral data 24 and purchases the product. Consumer B only has a First Degree influencer in this trend. Consumer B gets 50% of the sponsorship incentive 40. In the example, Consumer B receives 5% as a discount, cashback, points or in-store credit depending on how the incentive 40 is implemented. Consumer A also receives the other 5% of Consumer B's purchase price as cashback, points or in-store credit depending on how the incentive 40 is implemented.

Continuing the example, Consumer E may acknowledge Consumer B as his referral data 24 and buys the product. Consumer E has Consumer B as his First Degree influencer, but also has Consumer A as his Second Degree influencer in this trend. Consumer E gets 50% of the sponsorship incentive 40 (in the provided example is 5%) as a discount, cashback, points or in-store credit depending on how the incentive 40 is implemented. At this point, the trend network 42 has a First Degree influencer (i.e., Consumer B) and a Second Degree influencer (i.e., Consumer A), who contributed to generate the purchase. The system 10 may also split the remaining 50% of the incentive 40 among the trend network members that directly or indirectly influenced the purchase. In this example, the system 10 splits the remaining percent of the incentive 40 between Consumer B and his own direct influencer consumer (i.e., Consumer A). As a result, Consumer B and Consumer A each get 2.5% of Consumer E's purchase price as cashback, points or in store credit depending on how the incentive 40 is implemented.

Basically, the system 10 splits the incentive 40 in a given pro-rata proportion in each of the nodes of the trend network 42, regardless of how many degrees of dependency 28 the purchase has within the trend network 42.

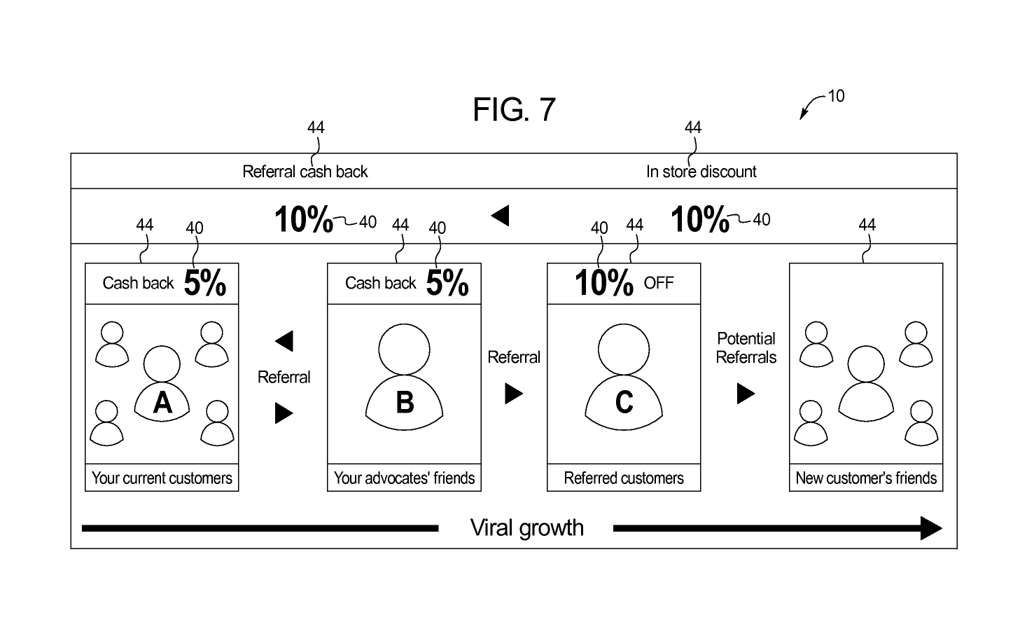

In another example, as shown in FIG. 7, a business may offer a 10% referral reward 44 as the incentive 40. The system 10 may charge a 5% transaction fee adding to a total cost of 15% per referred purchase. If Customer C spends $100 and gets a $10 discount, the system 10 distributes the $10 in cash back among the referring trend network such that each of the consumers within the trend network 42 shares a portion of the cash back. Therefore, Customer B may receive $5 in cash back and Customer A may receive $5 in cash back. The system 10 may charge $5 to the business sponsoring the incentive 40.

As there may be more than one trend network 42 of a given account product information 27 (e.g. a consumer creates a trend of a Titleist® driver bought at Golfsmith® Chicago, and another consumer creates a new trend of the same Titleist® driver but bought at a Golf Galaxy® store in another location), the system 10 may assign a code to each trend network 42 including geographical, demographic, and product information provided by members of the trend network 42. As a result, the system 10 may generate a community (i.e., product galaxy) of the Titleist® driver across the world and allow its members to interact, share their activities, photos, videos, tips or thoughts, and engage in the community in real time. Consumers may also be able to generate communities of more than one single product and invite the consumers of those products to join. For example: a consumer may create a community of golfers who use the Titleist® driver and also drink Samuel Adams® craft beer, and a group of people who share that passion and buy those products will be invited to join.

The system 10 may also measure the influence that each consumer has in terms of influenced sales of a given product and provide a trending score 30 for each consumer in each category of commerce. The trending score 30 will not only take into account the number of consumers that directly join a given consumer's trend (First Degree influenced purchases) but also the number of consumers that join the trend network 42 in further degrees, as well as the money the consumers spent on those purchases. The system 10 may aggregate all the information from every trend network 42 the referral account 26 has joined in a single trending score 30.

In another embodiment, the system 10 includes a controller 12 and a memory 14 coupled to the controller 12, wherein the memory 14 is configured to store program instructions executable by the controller 12. In response to executing the program instructions, the controller 12 is configured to receive a purchase information 20 from a consumer, wherein the purchase information 20 includes a product identification 22, a price of the associated purchase, and a referral data 24. The controller 12 is configured to identify a referral account 26 in a database 18 storing a plurality of referral accounts 26, wherein the identified referral account 26 corresponds to the received referral data 24. The controller 12 is also configured to indicate a dependency 28 between the consumer 19 and referral account 26 associated with the received referral data 24 in the database 18, and generate a trending score 30 associated with the referral account 26, wherein the trending score 30 is based a number of dependencies 28 associated with the referral account 26.

In an example, the controller 12 is further configured to generate the trending score 30 based on at least one of the purchase information 20, the product information 22, or the number of dependencies 28 defined in the referral account 26.

The controller 12 may be configured to generate a trending map 36 (e.g., a social graph) based on the defined dependencies 28, wherein the trending map 36 is in the form of a dependency tree. The controller 12 may also be configured to generate an incentive 40 associated with the referral account 26 based on the trending score 30 of the referral account 26, wherein the incentive 40 is redeemable with a business associated with the purchase information 20 The incentive 40 may be based on a product or set of products associated with the product information 22.

As mentioned above and schematically shown in FIG. 1, aspects of the systems 10 and methods described herein are controlled by one or more controllers 12. The one or more controllers 12 may be adapted to run a variety of application programs, access and store data, including accessing and storing data in the associated databases 18, and enable one or more interactions as described herein. Typically, the controller 12 is implemented by one or more programmable data processing devices. The hardware elements, operating systems, and programming languages of such devices are conventional in nature, and it is presumed that those skilled in the art are adequately familiar therewith.

For example, the one or more controllers 12 may be a PC-based or mobile device based implementation of a central control processing system utilizing a central processing unit (CPU), memory 14 and an interconnect bus. The CPU may contain a single microprocessor, or it may contain a plurality of microprocessors for configuring the CPU as a multi-processor system. The memory 14 may include a main memory, such as a dynamic random access memory (DRAM) and cache, as well as a read only memory, such as a PROM, EPROM, FLASH-EPROM, or the like. The system may also include any form of volatile or non-volatile memory 14. In operation, the memory 14 stores at least portions of instructions for execution by the CPU and data for processing in accord with the executed instructions.

The one or more controllers 12 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 12 may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces 16 for the controller 12. For example, the one or more controllers 12 may include a graphics subsystem to drive the output mechanism. The links of the peripherals to the system may be wired connections or use wireless communications.

Although summarized above as a PC-type implementation, those skilled in the art will recognize that the one or more controllers 12 also encompasses systems such as host computers, servers, workstations, network terminals, and the like. Further one or more controllers 12 may be embodied in a device, such as a mobile electronic device, like a smartphone or tablet computer. In fact, the use of the term controller 12 is intended to represent a broad category of components that are well known in the art.

Hence aspects of the systems 10 and methods 11 provided herein encompass hardware and software for controlling the relevant functions. Software may take the form of code or executable instructions for causing a controller 12 or other programmable equipment to perform the relevant steps, where the code or instructions are carried by or otherwise embodied in a medium readable by the controller 12 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory 14 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 12 can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method and portable electronic device may be provided based on various combinations of the features and functions from the subject matter provided herein.

We claim:

1. An inverse referral system comprising:
a controller;
a memory coupled to the controller, wherein the memory is configured to store program instructions executable by the controller;
wherein in response to executing the program instructions, the controller is configured to:
receive a purchase information and a referral data from a consumer, wherein the purchase information includes a product information;
access a database including a plurality of referral accounts associated with at least one account product information;
if the received product information and received referral data matches a referral account and associated account product information in the database, define a dependency within the database between the referral account and the consumer; and
generate a trending score associated with the referral account associated with the received referral data, wherein the trending score is based the dependency associated with the referral account.

2. The system of claim 1 wherein the purchase information includes at least one of a price data, a transaction data, a store data, a brand data, a location data, a time data, or customer feedback data.

3. The system of claim 1 wherein the controller is further configured to generate the trending score of a referral account based on at least one of the purchase information, the product information, or a quantity of dependencies associated with the referral account.

4. The system of claim 1 wherein the controller is further configured to display the product information on a user interface.

5. The system of claim 1 wherein the purchase information includes geographic or demographic information associated with the consumer.

6. The system of claim 1 wherein the controller is further configured to calculate a weighted dependency associated with the dependency, wherein the weighted dependency is based on a degree of dependency between the referral account and the consumer, wherein the weighted dependency is stored in the database associated with the dependency, and wherein the trending score is based on the weighted dependencies associated with the referral account.

7. The system of claim 1 wherein the referral account includes an identification code indicating a number and a degree of the received referral, wherein the number indicates an order in time the controller received the referral data, wherein the degree indicates a degree of dependency between the consumer and the referral account.

8. The system of claim 1 wherein the controller is further configured to generate an identification code associated with the consumer, wherein the identification code indicates a degree of dependency between the consumer and the referral account.

9. The system of claim 8 wherein the controller is further configured to generate a trending map based on at least two identification codes, wherein the trending map is in the form of a dependency tree.

10. The system of claim 1 wherein the controller is further configured to generate a trending map based on the defined dependencies, wherein the trending map is in the form of a dependency tree.

11. The system of claim 1 wherein the controller is further configured to receive purchase verification data before generating a trending score associated with the consumer.

12. The system of claim 11 wherein the purchase verification data includes at least one of a product bar code, receipt of purchase, bank account statement, product series code, or redeemed coupon code.

13. The system of claim 11 wherein the purchase verification data includes authorization from a business associated with the purchase information.

14. The system of claim 1 wherein the controller is further configured to communicate the trending score to a business associated with the purchase information.

15. The system of claim 1 wherein the controller is further configured to generate an incentive associated with the referral account based on the trending score of the referral account, wherein the incentive is redeemable with a business associated with the purchase information.

16. The system of claim 15 wherein the controller is further configured to generate a referral reward associated with the referral account associated with the received referral data, wherein the referral reward is based on at least one of the incentive, the purchase information, the product information, or a quantity of dependencies associated with the referral account.

17. An inverse referral system comprising:
a controller;
a memory coupled to the controller, wherein the memory is configured to store program instructions executable by the controller;
wherein in response to executing the program instructions, the controller is configured to:
receive a purchase information from a consumer, wherein the purchase information includes a product identification, a price of the associated purchase, and a referral data;
identify a referral account in a database storing a plurality of referral accounts, wherein the identified referral account corresponds to the received referral data;
indicate a dependency between the consumer and referral account associated with the received referral data in the database; and
generate a trending score associated with the referral account, wherein the trending score is based a number of dependencies associated with the referral account.

18. The system of claim 16 wherein the controller is further configured to generate the trending score based on at least one of the purchase information, the price, or the product information.

19. The system of claim 16 wherein the controller is further configured to generate a trending map based on the defined dependencies, wherein the trending map is in the form of a dependency tree.

20. The system of claim 16 wherein the controller is further configured to generate an incentive associated with the referral account based on the trending score of the referral account, wherein the incentive is redeemable with a business associated with the purchase information.
